(19) United States
(12) Patent Application Publication
(10) Pub. No.: US 2026/0029082 A1
(43) Pub. Date: Jan. 29, 2026

(54) DISPLAY MOUNTING SYSTEM

(71) Applicant: Ergotron, Inc., St. Paul, MN (US)

(72) Inventors: David Martin Lunde, Eagan, MN (US); Eric c. Dommeyer, Houlton, WI (US)

(21) Appl. No.: 18/994,483

(22) PCT Filed: Jul. 11, 2023
(86) PCT No.: PCT/US2023/027381

§ 371 Date: Jan. 14, 2025

Related U.S. Application Data
(60) Provisional application No. 63/389,196, filed on Jul. 14, 2022.

(51) Int. Cl. F16M 11/08; F16M 11/26

(52) U.S. Cl. CPC F16M 11/08; F16M 11/26

(57) ABSTRACT

A display mounting system can include a frame and a special linkage mechanism is described. The display mounting system can include one or more display attachment brackets to support one or more electronic displays. The frame can be coupled to a structure to hold the one or more electronic displays proximate a structure. The linkage assembly can allow the user of the display mounting system to easily change the configuration of one or more electronic displays between a stowed configuration and deployed configuration.

### CLAIM OF PRIORITY

This patent application claims the benefit of priority of Lunde, et al. U.S. Provisional Patent Application Ser. No. 63/389,196, entitled “HORIZONTAL FOLDING AND UNFOLDING DISPLAY MOUNTING ASSEMBLY FOR LARGE DISPLAYS,” filed on Jul. 14, 2022 (Attorney Docket No 5983.474PRV), which is hereby incorporated by reference herein in its entirety.

### TECHNICAL FIELD

This document pertains generally, but not by way of limitation, to a display mounting system to mount one or more flat panel displays to a structure.

### BACKGROUND

One or more displays can be used in various workstation applications (e.g., surgical carts, financial desks, data centers, or the like). In these applications, a display mounting system can be used to couple the one or more displays to a structure including, but not limited to, carts, cabinets, racks, walls, or the like. The display mounting system can provide flexibility to change the orientation of the one or more displays relative to the structure and relative to each other. In some example configurations, the display mounting system can selectively alter the position of the one or more displays between a stowed configuration (e.g., the one or more displays can face each other in a compact footprint) and a deployed configuration (e.g., the one or more displays can be side-by-side in an extended footprint).

### BRIEF DESCRIPTION OF THE DRAWINGS

The following drawings are illustrative of particular embodiments of the present invention and therefore do not limit the scope of the invention. The drawings are not to scale and are intended for use in conjunction with the explanations in the following detailed description. Like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of a mobile workstation according to an example configuration of the current disclosure.

FIG. 2 is a perspective view of a mobile workstation according to an example configuration of the current disclosure.

FIG. 3 is a perspective view of a mobile workstation according to an example configuration of the current disclosure.

FIG. 4 is a perspective view of the display mounting system according to an example configuration of the current disclosure.

FIG. 5 is a perspective view of the display mounting system of FIG. 4.

FIG. 6 is a top view of the first arm of FIG. 5.

FIG. 7 is a perspective view of the second arm of FIG. 5.

FIG. 8 is a perspective view of the slider of FIG. 5.

FIG. 9 is a top view of the display mounting system of FIG. 4.

FIG. 10 is a top view of the display mounting system of FIG. 4.

FIG. 11 is a top view of the display mounting system of FIG. 4.

FIG. 12 is a top view of the display mounting system of FIG. 4.

FIG. 13 is a top view of the display mounting system according to an example configuration of the current disclosure.

FIG. 14 is a top view of the display mounting system of FIG. 13.

### OVERVIEW

This disclosure describes a display mounting system to hold one or more displays relative to a structure including, but not limited to, a wall, a wheeled base, a cabinet, or the like. The display mounting system can have a linkage mechanism to easily change the configuration of the one or more displays relative to the structure. In some configurations, the one or more displays can be positioned in a stowed configuration where the one or more displays can face each other, in other configurations, the one or more displays can be positioned in a deployed (e.g., use) configuration where the one or more displays can be side-by-side facing the same direction.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

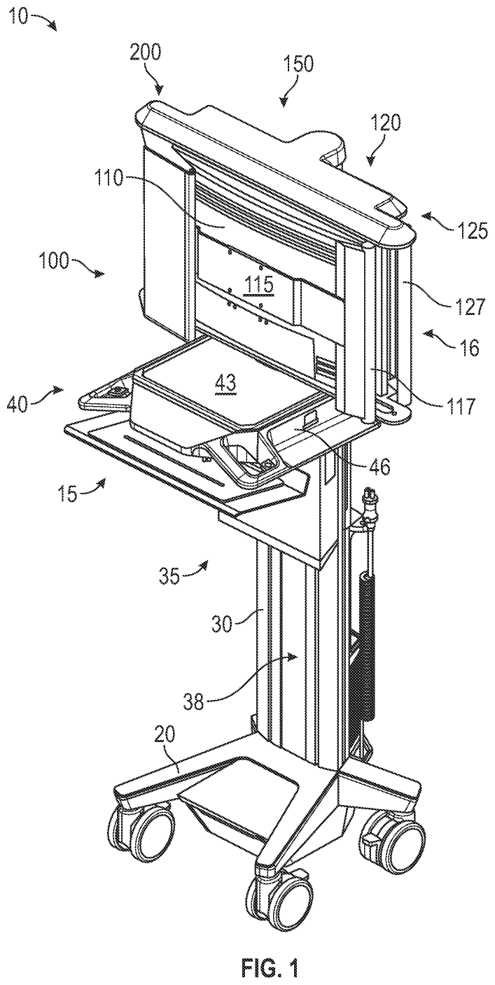

FIG. 1 is a perspective view of an example of a mobile workstation 10. The mobile workstation 10 can include a wheeled base 20, and a support column 30 coupled to the wheeled base 20. The mobile workstation 10 can have a front portion 15 and a rear portion 16. The wheeled base 20 can extend from the support column 30 toward the front portion 15. The mobile workstation 10 can be moved at least towards a rearward direction by a user positioned in front of the front portion 15 of the mobile workstation 10.

A movable bracket 35 can be slidably engaged with the support column 30. A work platform 40 can be coupled to the movable bracket 35. The work platform 40 can extend from the movable bracket 35 towards the front portion 15 of the mobile workstation 10. Additionally, a counterbalance mechanism 38 can be included in the support column 30. The counterbalance mechanism 38 can be connected to the support column 30 and can be coupled to the movable bracket 35. The counterbalance mechanism 38 can provide height adjustment for the movable bracket 35. The distance between the wheeled base 20, and the work platform 40 can be selectively adjusted by translating the movable bracket 35 with respect to a portion of the support column 30.

In some example configurations, the support column 30 can include a stationary portion coupled to a wheeled base 20 and a movable portion coupled to the work platform 40. The movable portion can be slidingly engaged with the stationary portion in a telescoping arrangement to adjust a height of the support column 30. A counterbalance mechanism 38 can be included inside the support column 30. The counterbalance mechanism 38 can be coupled between the stationary portion and the movable portion. The counterbalance mechanism 38 can provide height adjustment for the movable portion. The distance between the wheeled base 20 and the work platform 40 can be selectively adjusted by translating the movable portion with respect to the stationary portion of the support column 30.

In other example configurations, the support column 30 can be made of a single structural component having a first end coupled to the wheeled base 20 and a second end coupled to the work platform 40. The work platform 40 can be located at a fixed height relative to the wheeled base 20.

The work platform 40 can include a work surface 43 and a storage compartment 46, for example, the storage compartment 46 can be located beneath the work surface 43. Additionally, a keyboard tray can be coupled to the work platform 40, for example, the keyboard tray can be located below the storage compartment 46.

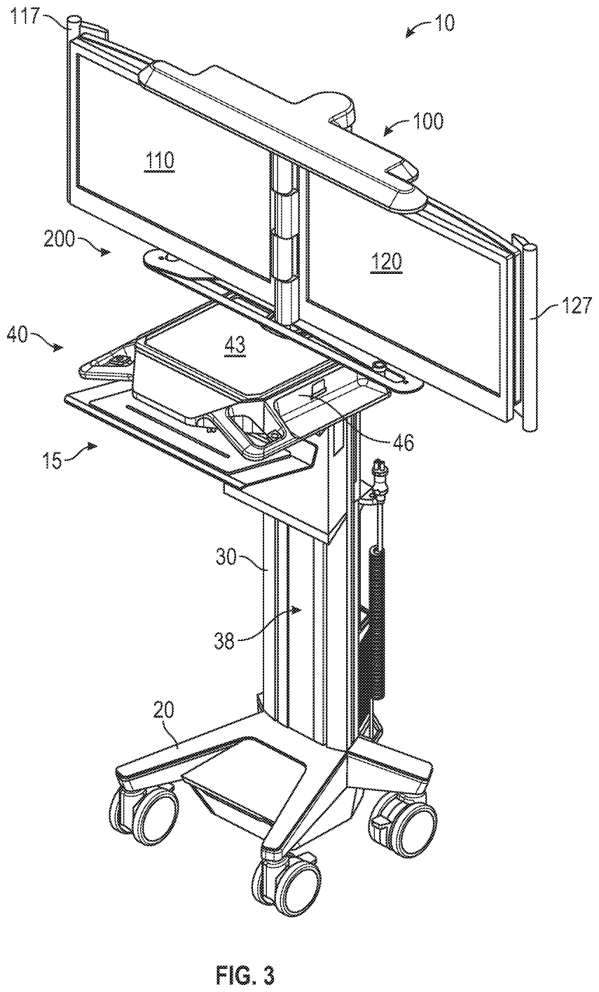

A display mounting system 100 can be coupled to the mobile workstation 10, for example, the display mounting system 100 can be located above the work surface 43. The display mounting system 100 can hold one or more displays (e.g., a first display 110 and a second display 120) above the work surface 43. In some example configurations, the display mounting system 100 can include a linkage assembly 200. As described herein, the linkage assembly 200can provide some articulation for the one or more displays relative to the work surface 43. The linkage assembly 200 can alter the orientation of the one or more displays between a stowed configuration (e.g., the one or more displays can face each other, as illustrated in FIG. 1) and a deployed configuration (e.g., the one or more displays can be side-by-side facing the same direction, as illustrated in FIG. 3). In the stowed configuration, a footprint of the mobile workstation 10 is reduced for compact use, stowage, or transition of the mobile workstation 10.

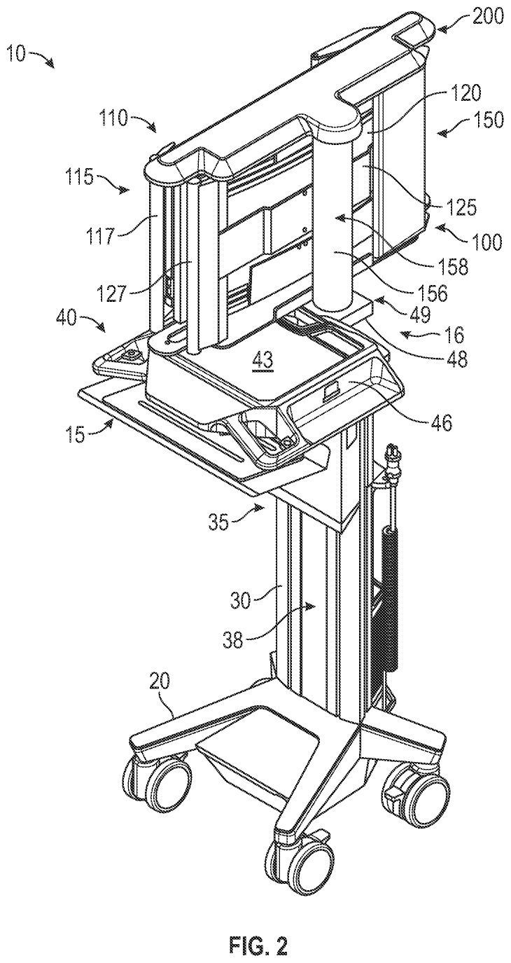

FIG. 2 shows the display mounting system 100 of the mobile workstation 10 in a stowed configuration. In some example configurations, the display mounting system 100 can be configured to rotate relative to the work platform 40, for example, rotate ninety degrees to align the one or more displays with a direction towards the rear portion 16 of the mobile workstation 10 to open the line of sight during the transition of the mobile workstation 10 from a first position to a second position.

In some example configurations, the mobile workstation 10 can include a pole 49. The pole 49 can be coupled to the work platform 40 via a work platform extension 48. The work platform extension 48 can be proximate the rear portion 16 of the mobile workstation 10. The pole 49 can extend in a vertical direction above the work platform extension 48. The pole 49 can form a rotation axis for the display mounting system 100. The display mounting system 100 can be configured to rotate around the rotation axis relative to the work platform 40.

FIG. 3 shows the display mounting system 100 of the mobile workstation 10 in a deployed configuration. The one or more displays (e.g., the first display 110 and the second display 120) can be located side-by-side facing the same direction (e.g., facing the front portion 15 of the mobile workstation 10) above the work surface 43. The one or more displays can be electronically coupled to a computer located on the mobile workstation 10 (e.g., located inside the storage compartment 46). A user of the mobile workstation 10 positioned in front of the work surface 43 (e.g., located proximate the front portion 15) can view images displayed on the one or more displays.

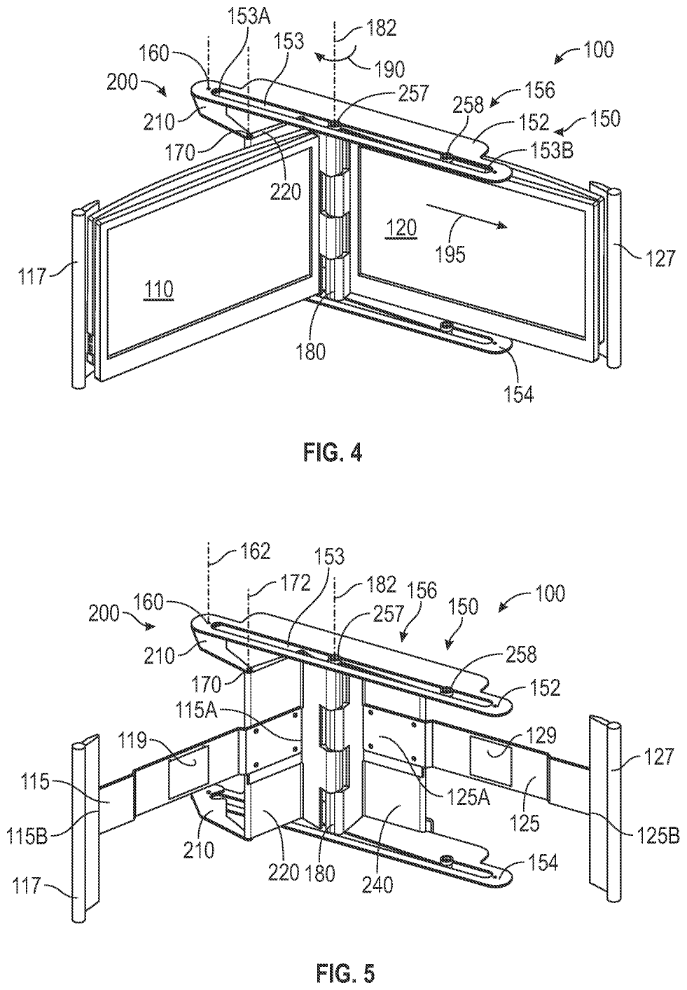

FIG. 4 is a perspective view of the display mounting system 100 according to an example configuration of the current disclosure. The display mounting system 100 can include a frame 150 and a linkage assembly 200. The frame 150 can be coupled to a structure (e.g., a support column, a wheeled base, a cabinet, a rack, a pole, and a wall). The linkage assembly 200 can be movably (e.g., rotatably, slidably, or the like) coupled to the frame 150.

The frame 150 can include a first slide bracket 152, a second slide bracket 154, and a spanner bracket 156 extending between the first slide bracket 152 and the second slide bracket 154. The spanner bracket 156 can be coupled to the first slide bracket 152 one on end and coupled to the second slide bracket 154 on the other end to form the frame 150. In some example configurations, the frame 150 can be fixedly attached to the structure (e.g., fixedly attached to a wheeled base 20).

In other example configurations, the frame 150 can be rotatably coupled to the structure (e.g., rotatably coupled to the work platform 40, as illustrated in FIG. 2). The spanner bracket 156 can be a tube having an aperture 158 located proximate a center of the tube, as illustrated in FIG. 2. The aperture 158 can start from the second slide bracket 154 and extend at least partially through the tube towards the first slide bracket 152. The pole 49 (shown in FIG. 2) can be coupled to the work platform extension 48 and at least partially located inside the aperture 158. The display mounting system 100 can be configured to rotate around the rotation axis defined by the pole 49.

The first slide bracket 152 and the second slide bracket 154 can be flat components having a width and a length larger than the width. The second slide bracket 154 can be parallel to and spaced apart from the first slide bracket 152. A slot 153 can be formed on the first slide bracket 152 and the second slide bracket 154. The slot 153 can be elongated from a first end 153A to a second end 153B along the lengths of the first slide bracket 152 and the second slide bracket 154.

FIG. 5 is a perspective view of the display mounting system 100 according to an example configuration of the current disclosure. The linkage assembly 200 can include one or more first arms 210, a second arm 220 and a slider 240. The slider 240 can be slidably coupled to the first slide bracket 152 and the second side bracket 154. The slider 240 can be configured to slide along the slots 153 located on the first slide bracket 152 and the second slide bracket 154. The second arm 220 can be rotatably coupled to the slider 240 about a pivot axis 182. The one or more first arms 210 can be rotatably coupled to the first slide bracket 152 and the second slide bracket 154 on one end, and rotatably coupled to the second arm 220 on the other end. The linkage assembly 200 can be configured to change an orientation of the one or more displays relative to the mobile workstation 10 (as illustrated in FIGS. 1-3).

The display mounting system 100 can also include a first strut 115 and a second strut 125, as illustrated in FIG. 5. The first strut 115 can be elongated between a first end 115A and the second end 115B, and the second strut 125 can be elongated between a first end 125A and the second end 125B. The first end 115A of the first strut 115 can be coupled to the second arm 220, and a first handle 117 can be coupled to the second end 115B of the first strut 115. The first end 125A of the second strut 125 can be coupled to the slider 240, and a second handle 127 can be coupled to the second end 125B of the second strut 125.

The display mounting system 100 can also include a first display interface 119 and a second display interface 129. The first display interface 119 and the second display interface 129 can be coupled to the first strut 115 and the second strut 125, respectively. The first display interface 119 and the second display interface 129 can be coupled to the first display 110 (FIG. 3) and the second display 120 (FIG. 3), respectively. The first display 110 and the second display 120 can be positioned over the first strut 115 and the second strut 125 such that the first handle 117 and the second handle 127 can be accessible on the sides of the first display 110 and the second display 120, respectively. A user of the display mounting system 100 can activate (e.g., move, rotate, or the like) the linkage assembly 200 by manipulating (e.g., pull, push, rotate, or the like) one or both of the first handle 117 and the second handle 127 to change an orientation of the first display 110 and the second display 120 relative to each other.

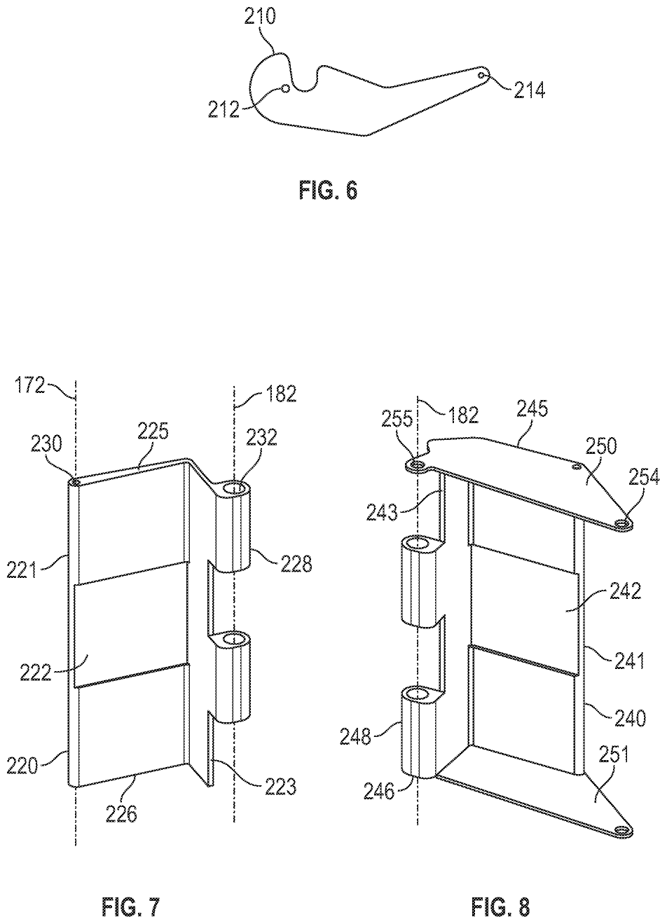

FIG. 6 is a top view of one or more first arms 210 according to an example configuration of the current disclosure. A first aperture 212 and a second aperture 214 away from the first aperture 212 can be formed on the one or more first arms 210. The one or more first arms 210 can be formed from a material including, but not limited to, stamped sheet metal, cast aluminum, molded plastic, or the like. The one or more first arms 210 can be rotatably coupled to the first slide bracket 152 and the second slide bracket 154 at the first aperture 212 of the first arm 210.

FIG. 7 is a perspective view of the second arm 220 according to an example configuration of the current disclosure. The second arm 220 can have a second arm body 222 extending from a first end 221 to a second end 223. The second arm body 222 can be formed in a profile including, but not limited to, an L-shape profile, a flat profile, a curved profile, or the like, between the first end 221 and the second end 223 of the second arm 220. The second arm body 222 can extend from an upper end 225 to a lower end 226 in a vertical direction. One or more second arm extensions 228 can be formed on the second end 223 of the second arm 220. The second arm 220 can include a first aperture 230 (e.g., proximate to the first end 221 of the second arm 220) and a second aperture 232 (e.g., proximate to the second end 223 of the second arm 220). The first aperture 230 and the second aperture 232 can extend from the upper end 225 of the second arm 220 to the lower end 226 of the second arm 220. The first aperture 230 of the second arm 220 and the second aperture 232 of the second arm 220 can have a round cross-section.

FIG. 8 is a perspective view of the slider 240 according to an example configuration of the current disclosure. The slider 240 can have a slider body 242 extending from a first end 241 to a second end 243 in a horizontal direction. The slider body 242 can be formed in a profile including, but not limited to, an L-shape profile, a flat profile, a curved profile, or the like, between the first end 241 of the slider 240 and the second end 243 of the slider 240. The slider body 242 can extend from an upper end 245 to a lower end 246. One or more slider extensions 248 can be formed on the second end 243 of the slider 240.

In some example configurations, the slider 240 can include an upper plate 250 coupled to the upper end 245 of the slider 240, and a lower plate 251 coupled to the lower end 246 of the slider 240. The upper plate 250 and the lower plate 251 can be fixedly attached to the slider 240. In other example configurations, the upper plate 250 and the lower plate 251 can be formed as an integral part of the slider body 242. The slider 240 can include a first aperture 254 (e.g., proximate to the first end 241 of the slider 240) and a second aperture 255 (e.g., proximate to the second end 243 of the slider). The first aperture 254 and the second aperture 255 can extend from the upper end 245 of the slider 240 to the lower end 246 of the slider. The first aperture 254 and the second aperture 255 of the slider 240 can have a round cross-section.

In some example configurations, an assembly of the one or more first arms 210 (FIG. 6), the second arm 220 (FIG. 7) and the slider 240 (FIG. 8) can be located between the first slide bracket 152 and the second slide bracket 154, as illustrated in FIG. 5. The one or more first arms 210 can be rotatably coupled to the first slide bracket 152 and the second slide bracket 154 at a first hinge 160 defining a first axis 162. The one or more first arms 210 can be configured to rotate relative to the first slide bracket 152 and the second slide bracket 154 about the first axis 162.

The second aperture 214 of the one or more first arms 210 can be concentric with the first aperture 230 of the second arm 220. A mechanical fastener can be inserted through the second aperture 214 of the one or more first arms 210 and the first aperture 230 of the second arm 220 to form a second hinge 170 defining a second axis 172. The second axis 172 can be parallel with the first axis 162. The one or more first arms 210 can be configured to rotate relative to the second arm 220 about the second axis 172.

The one or more second arm extensions 228 can overlap with the one or more slider extensions 248 such that the second aperture 232 of the second arm 220 and the second aperture 255 of the slider 240 can be concentric. A mechanical fattener can be inserted through the second aperture 232 of the second arm 220 and the second aperture 255 of the slider 240 to form a pivot 180 defining a pivot axis 182. The second arm 220 can be adapted to rotate relative to the slider 240 about the pivot axis 182. The pivot axis182 can be parallel with the first axis 162 and the second axis 172. The pivot axis 182, the first axis 162 and the second axis 172 can be oriented in a vertical direction.

In some example configurations, the display mounting system 100 can include one or more first rollers 257 and one or more second rollers 258 (shown in FIGS. 4-5). The one or more first rollers 257 and the one or more second rollers 258 can be coupled to the upper plate 250 and the lower plate 251. The one or more first rollers 257 can be concentric with the first aperture 254 of the slider 240, and the one or more second rollers 258 can be concentric with the second aperture 255 of the slider 240. The one or more first rollers 257 and the one or more second rollers 258 can be placed inside the slot 153 located on the first slide bracket 152 and the second slide bracket 154. The one or more first rollers 257 and the one or more second rollers 258 can be configured to translate along the slot 153.

In some example configurations, the one or more first rollers 257 and the one or more second rollers 258 (shown in FIGS. 4-5) can be rotatingly coupled with the slider 240. In other example configurations, the one or more first rollers 257 and the one or more second rollers 258 can be fixedly attached to the slider 240 (e.g., attached as a pin).

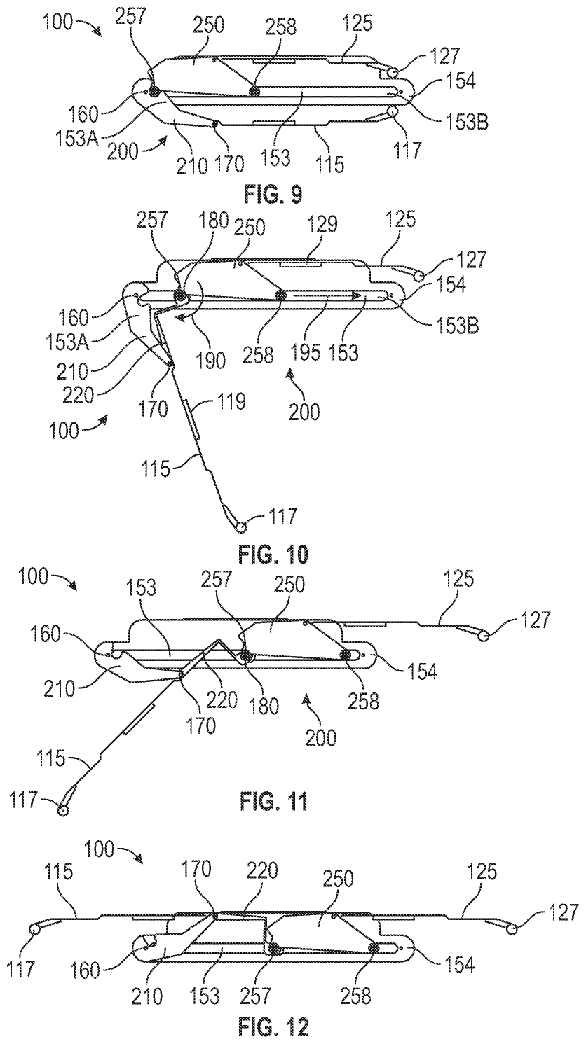

FIGS. 9-12 are top views of the display mounting system of FIG. 5 at different amounts of rotations between the first strut 115 and the second strut 125. The first slide bracket 152 is removed from FIGS. 9-12 to make the upper plate 250 of the slider 240 visible. The linkage assembly 200 is illustrated in the stowed configuration in FIG. 9. In the stowed configuration, the second roller can be proximate the first end 153A of the slot 153, and the first strut 115 can be located across from the second strut 125. The first display 110 can face the second display 120 in the stowed configuration, as illustrated in FIG. 1.

The first strut 115 can be configured to rotate in a first direction 190 (e.g., in a clockwise direction) to unfold the linkage assembly 200 to move the first display 110 away from the second display 120 and to put the display mounting system 100 into the deployed configuration. During the rotation of the first strut 115 in the first direction 190, the upper plate 250 and the lower plate 251 coupled to the slider 240 can translate in a second direction 195. The second direction 195 can be parallel to the slot 153. The one or more first rollers 257 and the one or more second rollers 258 can guide the slider 240 during the translation in the second direction 195.

The first strut 115 can rotate relative to the second strut 125 about 180 degrees in the first direction 190 about the pivot axis 182 to put the display mounting system 100 into the deployed configuration, as illustrated in FIG. 12. The slider 240 can move towards the second end 153B of the slot 153. In the deployed configuration, the one or more first rollers 257 can be proximate the second end 153B of the slot 153. In the deployed configuration, the first display 110 and the second display 120 can face the same direction (e.g., face the direction of a user of the mobile workstation 10 located in front of the front portion 15 of the mobile workstation 10), as illustrated in FIG. 3.

A user of the display mounting system 100 can put the display mounting system 100 into the stowed configuration selectively, as illustrated in FIG. 9. The second arm 220 can be rotated in a direction opposite the first direction 190 (e.g., in a counterclockwise direction) relative to the slider 240 to fold the linkage assembly 200. This can force the slider 240 to move in a direction opposite the second direction 195 relative to the second slide bracket 154.

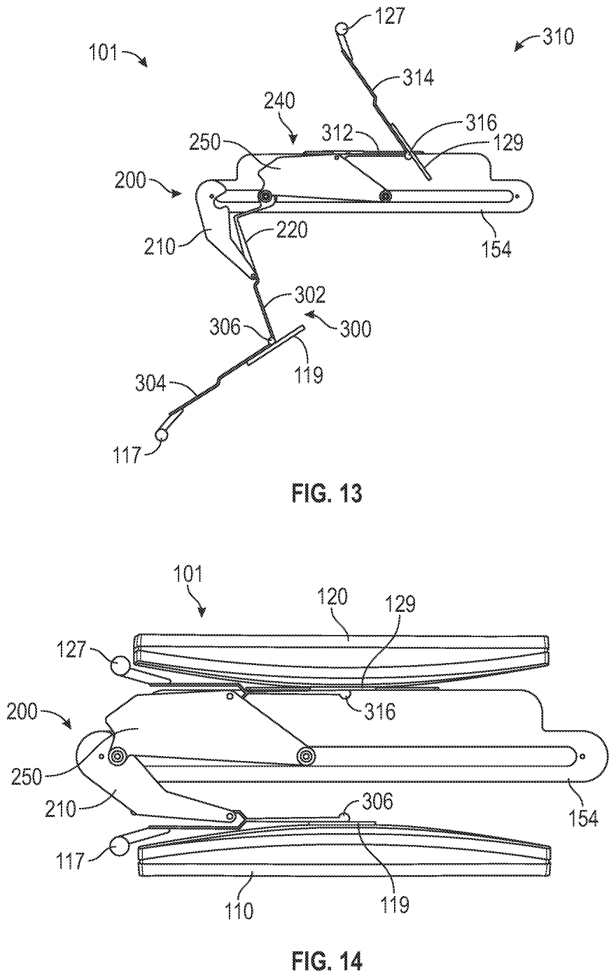

FIG. 13 is a top view of a display mounting system 101 according to an example configuration of the current disclosure. In some example configurations, the display mounting system 101 can include a first strut assembly 300 and a second strut assembly 310. The first strut assembly 300 can include a first portion 302, a second portion 304 and a first pan pivot 306. The first pan pivot 306 can be located between the first portion 302 and the second portion 304 of the first strut assembly 300. The first pan pivot 306 can be oriented in a vertical direction.

The first portion 302 of the first strut assembly 300 can be coupled to the second arm 220 on one end, and rotatably coupled to the second portion 304 of the first strut assembly 300 at the first pan pivot 306 on the other end. The second portion 304 of the first strut assembly 300 can be rotatably coupled to the first portion 302 of the first strut assembly 300 on one end and a first handle 117 can be coupled to the second portion 304 of the first strut assembly 300 on the other end. The second portion 304 of the first strut assembly 300 can be configured to rotate relative to the first portion 302 of the first strut assembly 300 about the first pan pivot 306.

A first display interface 119 can be coupled to the second portion 304 of the first strut assembly 300 proximate the first pan pivot 306. The first display interface 119 can be adapted to mount a first electronic display 110 to the linkage assembly 200, as illustrated in FIG. 14.

The second strut assembly 310 can include a first portion 312, a second portion 314, and a second pan pivot 316, as illustrated in FIG. 13. The second pan pivot 316 can be oriented in a vertical direction parallel to the first pan pivot 306. The second pan pivot 316 can be located between the first portion 312 of the second strut assembly 310 and the second portion 314 of the second strut assembly 310.

The first portion 312 of the second strut assembly 310 can be coupled to the slider 240 on one end, and rotatably coupled to the second portion 314 of the second strut assembly 310 at the second pan pivot 316 on the other end. The second portion 314 of the second strut assembly 310 can be rotatably coupled to the first portion 312 of the second strut assembly 310 on one end and a second handle 127 can be coupled to the second portion 314 of the second strut assembly 310 on the other end. The second portion 314 of the second strut assembly 310 can be configured to rotate relative to the first portion 312 of the second strut assembly 310 about the second pan pivot 316.

A second display interface 129 can be coupled to the second portion 314 of the second strut assembly 310 proximate the second pan pivot 316. The second display interface 129 can be adapted to mount a second display 120 to the linkage assembly 200, as illustrated in FIG. 14.

FIG. 14 is a top view of the display mounting system 101 in a stowed configuration. During folding of the linkage assembly 200 from deployed configuration to a stowed configuration, the first display 110 and the second display 120 can be rotated around the first pan pivot 306 and the second pan pivot 316, respectively. The first display 110 can rotate about the first pan pivot 306 (e.g., the second portion 304 of the first strut assembly 300 can rotate relative to the first portion 302 of the first strut assembly 300) in a clockwise direction, and the second display 120 can rotate about the second pan pivot 316 (e.g., the second portion 314 of the second strut assembly 310 can rotate relative to the first portion 312 of the second strut assembly 310) in a counterclockwise direction. In the stowed configuration, the first display 110 and the second display 120 can face the opposite directions (e.g., each can face away from the display mounting system 101) to allow the first display 110 and the second display 120 to be visible from opposite directions.

In some example configurations, the first pan pivot 306 and the second pan pivot 316 can be locked to prevent the rotation of the second portion 304 of the first strut assembly 300 relative to the first portion 302 of the first strut assembly 300, and to prevent the rotation of the second portion 314 of the second strut assembly 310 relative to the first portion 312 of the second strut assembly 310, respectively. In this configuration, the display mounting system 101 can act the same way as described in relation to FIGS. 9-12.

### Additional Notes and Aspects

Aspect 1 may include or use subject matter (such as an apparatus, a system, a device, a method, a means for performing acts, or a device readable medium including instructions that, when performed by the device, may cause the device to perform acts), such as may include or use a display mounting system comprising: a first display interface adapted to couple with a first electronic display; a second display interface adapted to couple with a second electronic display; a frame including: a first slide bracket; a second slide bracket parallel to and spaced-apart from the first slide bracket; and a spanner bracket coupled between the first slide bracket and the second slide bracket; wherein the frame is adapted to be mounted to a structure; and a linkage assembly operably coupled between the frame and the first display interface and the second display interface; wherein the linkage assembly is configured to change an orientation of the first electronic display interface and the second electronic display interface relative to the structure to selectively put the display mounting system in a stowed configuration or a deployed configuration.
Aspect 2 may include or use or may optionally be combined with the subject matter of Aspect 1, to optionally include or use, wherein the structure is any one one of: a support column, a wheeled base, a cabinet, a rack, a pole, and a wall.
Aspect 3 may include or use or may optionally be combined with the subject matter of Aspect 1, to optionally include or use, wherein the linkage assembly comprises: a slider slidably engaged with the frame; one or more first arms rotatably coupled to the frame; and a second arm rotatably coupled to at least one of the one or more first arms on one end and rotatably coupled to the slider on an other end opposite the one end; wherein rotation of the one or more first arms relative to the frame causes the slider translate relative to the frame.
Aspect 4 may include or use or may optionally be combined with the subject matter of Aspect 3, to optionally include or use, wherein the slider is slidably engaged with the first slide bracket and the second slide bracket; wherein the one or more first arms is rotatably coupled to the first slide bracket and the second slide bracket; and wherein rotation of the one or more first arms relative to the first slide bracket and the second slide bracket causes the slider to translate relative to the first slide bracket and the second slide bracket.
Aspect 5 may include or use or may optionally be combined with the subject matter of Aspect 3, to optionally include or use, wherein the display mounting system comprises: a first strut coupled to the second arm; and a second strut coupled to the slider; wherein the first strut is configured to translate relative to the second strut as the linkage assembly is operated.
Aspect 6 may include or use or may optionally be combined with the subject matter of Aspect 5, to optionally include or use, wherein the first display interface coupled to the first strut; and the second display interface coupled to the second strut; and wherein the first display interface and the second display interface are adapted to couple the first electronic display and the second electronic display to the display mounting system, respectively.
Aspect 7 may include or use or may optionally be combined with the subject matter of Aspect 6, to optionally include or use, wherein the display mounting system includes: a first handle coupled to the first strut; and a second handle coupled to the second strut; wherein the display mounting system is configured to be activated by manipulating one or both of the first handle and the second handle; wherein the first handle is proximate the second handle in the stowed configuration, and the first handle is spaced-apart from the second handle in the deployed configuration; and wherein the first electronic display is located across and faces the second electronic display in the stowed configuration, and the first electronic display is located such that the first electronic display and the second electronic display are facing a same direction in the deployed configuration.
Aspect 8 may include or use subject matter (such as an apparatus, a system, a device, a method, a means for performing acts, or a device readable medium including instructions that, when performed by the device, may cause the device to perform acts), such as may include or use a display mounting system comprising: a first display interface adapted to couple with a first electronic display; a second display interface adapted to couple with a second electronic display; a frame adapted to be mounted to a structure; a linkage assembly operably coupled between the frame and the first display interface and the second display interface; wherein the linkage assembly is configured to change an orientation of the first electronic display interface and the second electronic display interface relative to the structure to selectively put the display mounting system in a stowed configuration or a deployed configuration.
Aspect 9 may include or use or may optionally be combined with the subject matter of Aspect 8, to optionally include or use, wherein the frame comprises: a first slide bracket; a second slide bracket parallel to and spaced-apart from the first slide bracket; and a spanner bracket coupled between the first slide bracket and the second slide bracket.
Aspect 10 may include or use or may optionally be combined with the subject matter of Aspect 9, to optionally include or use, wherein the spanner bracket is a tube having an aperture; wherein the tube is coupled to the first slide bracket on one end and coupled to the second slide bracket on an other end opposite the one end; wherein the aperture extends at least partially through the tube from the first slide bracket towards the second slide bracket.
Aspect 11 may include or use or may optionally be combined with the subject matter of Aspect 10, to optionally include or use, wherein the structure is a mobile workstation comprising: a wheeled base; a support column coupled to the wheeled base; and a work platform having a front portion and a rear portion; wherein the work platform is coupled to the support column proximate the rear portion.
Aspect 12 may include or use or may optionally be combined with the subject matter of Aspect 11, to optionally include or use, wherein the mobile workstation comprises a work platform extension coupled to the rear portion of the work platform.
Aspect 13 may include or use or may optionally be combined with the subject matter of Aspect 12, to optionally include or use, wherein the mobile workstation also includes a pole coupled to the work platform extension; wherein the pole extends from the work platform extension in a transverse direction.
Aspect 14 may include or use or may optionally be combined with the subject matter of Aspect 13, to optionally include or use, wherein the pole is at least partially located inside the aperture; and wherein the display mounting system is configured to rotate relative to the mobile workstation about a rotation axis defined by the pole.
Aspect 15 may include or use subject matter (such as an apparatus, a system, a device, a method, a means for performing acts, or a device readable medium including instructions that, when performed by the device, may cause the device to perform acts), such as may include or use a display mounting system comprising: a frame adapted to be mounted to a structure; a linkage assembly operably coupled to the frame; a first strut assembly coupled to the linkage assembly; a second strut assembly coupled to the linkage assembly; a first display interface coupled to the first strut assembly; wherein the first display interface is adapted to hold a first electronic display; and a second display interface coupled to the second strut assembly; wherein the second display interface is adapted to hold a second electronic display; wherein, in cooperation with the first strut assembly and the second strut assembly, the linkage assembly is configured to change an orientation of the first electronic display and the second electronic display relative to the structure to selectively put the display mounting system in a stowed configuration or a deployed configuration.
Aspect 16 may include or use or may optionally be combined with the subject matter of Aspect 15, to optionally include or use, wherein the frame comprises: a first slide bracket; a second slide bracket parallel to and away from the first slide bracket; and a spanner bracket coupled between the first slide bracket and the second slide bracket.
Aspect 17 may include or use or may optionally be combined with the subject matter of Aspect 16, to optionally include or use, wherein the linkage assembly comprises: a slider slidably engaged with the first slide bracket and the second slide bracket; one or more first arms rotatably coupled to the first slide bracket and the second slide bracket; and a second arm rotatably coupled to the one or more first arms on one end and rotatably coupled to the slider on an other end opposite the one end; wherein rotation of the one or more first arms relative to the first slide bracket and the second slide bracket causes the slider to translate relative to the first slide bracket and the second slide bracket.
Aspect 18 may include or use or may optionally be combined with the subject matter of Aspect 17, to optionally include or use, wherein the first strut assembly comprises: a first portion coupled to the second arm; and a second portion coupled to the first portion at a first pan pivot.
Aspect 19 may include or use or may optionally be combined with the subject matter of Aspect 18, to optionally include or use, wherein the second strut assembly comprises: a first portion coupled to the slider; and a second portion coupled to the first portion at a second pan pivot.
Aspect 20 may include or use or may optionally be combined with the subject matter of Aspect 19, to optionally include or use, wherein the first display interface coupled to the second portion of the first strut assembly, and the second display interface coupled to the second portion of the second strut assembly; and wherein the first electronic display rotates about the first pan pivot in a clockwise direction, and the second electronic display rotates about the second pan pivot in a counterclockwise direction such that the first electronic display and the second electronic display face opposite directions in the stowed configuration.

Each of these non-limiting examples can stand on its own or can be combined in any permutation or combination with any one or more of the other examples.

The above detailed description includes references to the accompanying drawings, which form a part of the detailed description. The drawings show, by way of illustration, specific embodiments in which the present subject matter can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the present subject matter should be determined with reference to the appended claims, along with the full scope of equivalents to which such claims are entitled.

1-20. (canceled)

21. A display mounting system comprising:
a frame configured to be mounted to a structure, the frame including:
a spanner bracket defining a first end portion and a second end portion;
a first slide bracket coupled to the first end portion; and
a second slide bracket coupled to the second end portion, the second slide bracket parallel to the first slide bracket;
a linkage assembly operably coupled to the frame, the linkage assembly including:
a slider slidably engaged with the frame;
a first arm rotatably coupled to a lateral end portion of the first slide bracket; and
a second arm rotatably coupled to the first arm and the slider; and
a first display interface and a second display interface coupled to the linkage assembly.

22. The display mounting system of claim 21, wherein the structure includes at least one of a support column, a wheeled base, a cabinet, a rack, a pole, or a wall.

23. The display mounting system of claim 21, wherein the slider is slidingly engaged with the first slide bracket and the second slide bracket and the slider translates along the first slide bracket and the second slide bracket in response to rotation of the first arm.

24. The display mounting system of claim 21, wherein the linkage assembly includes:
a first strut coupled to the second arm; and
a second strut coupled to the slider.

25. The display mounting system of claim 24, wherein the linkage assembly includes:
a first handle coupled to the first strut; and
a second handle coupled to the second strut, the second handle configured to be proximate to the first handle in a stowed configuration of the display mounting system, and on opposing end portions of the display mounting system in a deployed configuration.

26. The display mounting system of claim 24, wherein the first display interface is coupled to the first strut, the first display interface configured to couple with a first electronic display, and the second display interface coupled to the second strut, the second display interface configured to couple with a second electronic display.

27. The display mounting system of claim 24, wherein the first strut is configured to rotate away from the second strut about a pivot axis when transitioning the display mounting system from a stowed configuration to a deployed configuration.

28. The display mounting system of claim 24, wherein the first strut includes:
a first portion coupled to the second arm and a first pan pivot; and
a second portion coupled to the first pan pivot, the first pan pivot configured to allow rotation of the second portion about a first pan pivot axis defined by the first pan pivot.

29. The display mounting system of claim 28, wherein the second strut includes:
a third portion coupled to the slider and a second pan pivot; and
a fourth portion coupled to the second pan pivot, the second pan pivot configured to allow rotation of the fourth portion about a second pan pivot axis defined by the second pan pivot.

30. The display mounting system of claim 29, wherein the second portion rotates in a counter clockwise direction about the first pan pivot and the fourth portion rotates in a clockwise direction about the second pan pivot when transitioning the display mounting system from a stowed configuration to a deployed configuration.

31. The display mounting system of claim 30, wherein the first display interface faces away from the second display interface in the stowed configuration, and the first display interface faces a same direction of the second display interface in a deployed configuration.

32. A display mounting system comprising:
a frame configured to be mounted to a structure; and
a linkage assembly slidably engaged with the frame via a slider, the linkage assembly coupled to a first electronic display via a first display interface and a second electronic display via a second display interface, the linkage assembly configured to unfold the first electronic display and the second electronic display in a continuous motion from a stowed configuration to a deployed configuration by rotating the first electronic display.

33. The display mounting system of claim 32, wherein the first electronic display faces the second display interface in the stowed configuration, and the first electronic display faces a same direction of the second electronic display in the deployed configuration.

34. The display mounting system of claim 32, wherein in the continuous motion, the slider translates along a first slide bracket of the frame and a second slide bracket of the frame, positioning the first electronic display facing a same direction as the second electronic display.

35. A display mounting system comprising:
a mobile workstation including:
a wheeled base;
a support column coupled to the wheeled base; and
a work platform defining a front portion and a rear portion, the work platform coupled to the support column at the rear portion;
a frame configured to be mounted on the mobile workstation; and
a linkage assembly coupled to the frame, the linkage assembly configured to change an orientation of a first electronic display interface and a second electronic display interface.

36. The display mounting system of claim 35, wherein the linkage assembly includes:
a slider engaged with a first slide bracket and a second slide bracket;
a first strut coupled to an arm and the first electronic display interface; and
a second strut coupled to the slider and the second electronic display interface.

37. The display mounting system of claim 35, wherein the frame includes:
a spanner bracket defining a first end portion and second end portion;
a first slide bracket coupled to the first end portion; and
a second slide bracket coupled to the second end portion, the second slide bracket parallel to the first slide bracket.

38. The display mounting system of claim 37, wherein the linkage assembly is configured to be slidingly engaged with the first slide bracket and the second slide bracket.

39. The display mounting system of claim 37, wherein the spanner bracket includes:
a longitudinal bore extending at least partially from the second end portion to the first end portion.

40. The display mounting system of claim 39, wherein the work platform includes:
a platform extension extending from the rear portion; and
a pole coupled to the platform extension, the pole configured to mate with the longitudinal bore and rotate the frame relative to the mobile workstation about an axis defined by the longitudinal bore.
